(19) United States
(12) Patent Application Publication
(10) Pub. No.: US 2009/0287881 A1
(43) Pub. Date: Nov. 19, 2009

(54) Environmentally protected data storage container

(76) Inventors: Peter Steven Kruus, Clarksville, MD (US); Michael David Heyman, Rockville, MD (US)

Correspondence Address: Peter Kruus, 6029 Ascending Moon Path, Clarksville, MD, 21029, US

(21) Appl. No.: 12/152,823

(22) Filed: May 17, 2008

(51) Int. Cl. G06F 12/00

(52) U.S. Cl. 711/114

(57) ABSTRACT

The Environmentally Protected Data Storage Container is a system comprising an environmentally protected box approximating the size of a shoebox of sufficient structural rigidity to withstand an underground environment. Within the box, a data storage interface with a connection to outside the box exists. The data storage interface provides an attachment point to a data storage device. The data storage device is protected from data loss due to destructive environmental forces. Furthermore, the system may contain specific thermal management, power management, and sensor devices.

This application is a continuation of provisional U.S. Application Ser. No. 60/930,716 filed on 17 May 2007, which applications are herein incorporated by reference.

### BACKGROUND OF THE INVENTION

The present invention, the Environmentally Protected Data Storage Container (hereafter referred to as the “system”), relates to the storage of electronic data such that it is protected from theft, fire, harsh weather conditions (e.g., extreme heat or cold), and natural and man-made catastrophes (e.g., flood, hurricane, tornado, earthquakes, explosions). While local data storage methods such as Redundant Array of Independent Disks (RAID) can protect against the physical or electronic failure of storage media, they themselves do not protect against environmental threats or other dangers that could destroy the entire data storage unit. Similarly, remote off-site backup methods may protect against some local environmental threats but do not offer the convenience and security of locally protected storage. The system is designed to support various forms of electronic storage while offering the convenience of immediate local physical access to one's data while protecting the data from harsh environmental threats.

### BRIEF SUMMARY OF THE INVENTION

The system is nominally a sturdy box designed to protect its internal contents from theft, fire, harsh weather conditions (e.g., extreme heat or cold), and natural and man-made catastrophes (e.g., flood, hurricane, tornado, earthquakes, explosions). Examples of the system's internal contents include electronic data storage system s such as network attached storage devices (NAS), digital video recorders (DVR), electronic media servers (e.g., music, video, digital images), etc. While data replication methods such as RAID protect against electronic failures of data storage mediums, they do not protect against physical and environmental threats. The system is designed to provide physical protection to electronic storage devices and their data while allowing the storage devices to operate normally while connected through wired or wireless connection to a data network.

The system is constructed in such a way that it protects against potentially harmful physical and environmental threats. The system may be buried within the earth at a nominal depth to protect it against these and other conditions, such as theft. The system may be buried at such a depth that its external temperature is held to a constant temperature (e.g., 50 degrees F.). The construction and design of the system is such that it seals out water, soil, heat, insects and other pests from the internal electronic data storage devices which can remain powered and connected to a data network. The system also protects against other physical threats including fire and theft.

Power for the internal contents of the system is provided from an external source as either a low voltage DC or regular AC, or optionally from an internal battery. The system's internal battery may provide short or long term power as an uninterruptible power supply (UPS) or serve as a surge protector. The AC and low voltage DC options have the appropriate standard plug inside the environmental envelope with a pass through environmental envelope.

In various embodiments of the system, the system may be constructed such that the health of the internal contents of the system and the system's internal operating environment can be remotely monitored from outside the system. This allows a remote operator to observe the health and status of the internal electronic data storage devices remotely without having to physically access the system.

### BRIEF DESCRIPTION OF THE SEVERAL VIEWS OF THE DRAWING

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of the invention showing the invention underground with power distribution, heat management, and data storage components.

FIG. 2 is a simplified block diagram of the invention that focuses on the internal sensors used to monitor the internal health and conditions within the system.

### DETAILED DESCRIPTION OF THE INVENTION

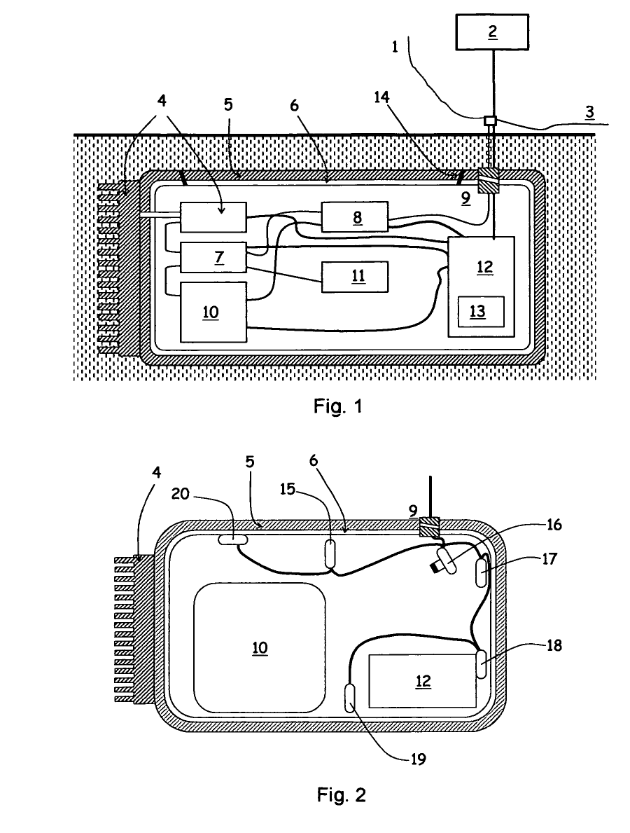

FIG. 1 shows the Environmentally Protected Data Storage Container (hereafter referred to as the “system”) being used to protect a networked hard drive 10. The container 5 is roughly 1 cubic foot in size and is constructed of concrete with an inner steel Faraday cage 6. The system contains a heat management system 4 comprised of an internal heat sink and fan connected to an external radiator via a heat pipe. The system is buried under the ground at a depth of 4 feet.

Communications to the network attached storage (NAS) box 10 from the external WiFi antenna 1 or the external Ethernet cable 3 enters the system through a rubberized envelope pass through 9 into an Ethernet switch 8. The NAS box 10 is connected to the Ethernet switch 8 through an Ethernet cable.

The NAS box 10 and its power supply 12 produce significant amounts of heat which must be dissipated from the system to maintain its reliability. The control unit 7 monitors a thermostat 11 so as the system warms it cycles on the fan of the heat management system 4 to circulate air over the heat sink.

Household power socket 2 delivers power to the system. Power enters the system through a rubberized envelope pass through 9 into an uninterruptable power supply (UPS) 12 with a battery backup 13. Power from the UPS 12 supplies the NAS box 10, Ethernet switch 8, and the control unit 7.

Prior to burying the system, the NAS box 10 is installed through by opening the access panel on the top of the system. Once the NAS box in connected to the system, the access panel is closed securely. The rubberized seal 14 on the access panel prevents environmental intrusions.

The control unit 7 monitors the UPS 12 so that if external power 2 fails it can signal the NAS box 10 so that it can perform an orderly shutdown without the loss of data. Likewise, when external power returns, the control unit 7 awakens the NAS box 10.

FIG. 2 details the sensor configuration within the system. These sensors are used to monitor the system's health and report it to an external operator. Sensors include an accelerometer 20 to detect earthquakes, nearby digging, or explosions. A microphone 15 can be an early indicator of imminent hard drive failure in the NAS box. A camera 16 can be used to monitor the external LEDs on the NAS box. A temperature sensor 17 measures the internal temperature of the system to verify that the system is operating within its ideal temperature range. A power failure sensor 18 monitors the internal power supply to aid in diagnosing power delivery failures. A water sensor detects the failure of the environmental envelope to keep water out.

The figures show the environmental envelope constructed from concrete with a steel Faraday cage. The materials used to construct the environmental envelope should be non-degradable and resistant to environmental stresses such as water, insects, animals, vibrations, fire, and freeze-thaw cycles. As such, other embodiments of the environmental envelope could be constructed from other non-degradable materials such as stainless steel, vinyl, plastic, glass, rubber, composites, or combinations of the forgoing. The materials must be capable of being formed into a sufficiently rigid structure to allow the system to be buried within the earth without causing any deformation or damage to the system or its internal contents. Likewise, the rubberized seal 14 could be replaced with equally effective measures for repelling environmental intrusions such as a screw top or cam activated device.

The figures show an environmental envelope protecting a NAS box 10. In other embodiments, the data storage device may include one or more of digital video recorder (DVR), electronic media server (e.g., music, video, digital images), telephone answering machine, or the like.

The figures show a heat management system 4 consisting of a heat sink with a fan connected to an external radiator through a heat pipe. Without allowing for heat dissipation, the internal temperature could rise causing the internal contents to overheat possibly resulting in an immediate or premature failure of the functionality of the internal contents. In other embodiments, the heat management system could be simply part of the external envelope itself, a low thermal resistance conductor such as copper instead of the heat pipe, or it could be a heat pump. A heat pump would be required where the internal contents must be warmed. To further protect the internal contents, one embodiment of the device is designed with insulation that helps to regulate the internal temperature of the device from outside temperature fluctuations.

The figures show an external AC household power supply 2 delivering power to an internal UPS 12. Another embodiment could use an external DC power supply such as from a solar array. Of course, the UPS is optional as is any power conditioning.

The figures show a Faraday cage 6 to protect against large voltage potential such as occur with a lightning strike. If the system is to be placed where this is not a concern, an embodiment may be produced without the Faraday cage.

The figures show an Ethernet 3 and WiFi 1 connection. Many other data connections are possible. Other embodiments of the system may include different forms of wired or wireless connections such as fiber optics, USB, Firewire, SATA, Bluetooth, analog sound and video, HDMI, WiMax, GPRS, EDGE, and any number of similar methods known to those skilled in the art.

The figures show the internal devices controlled through Ethernet (all passing through Ethernet switch 8). Some embodiments may have devices such as DVRs that can only be controlled via infra-red (IR) remote controllers. These embodiments would have an IR extender relaying the IR signal inside the environmental envelope (via IR extender specific copper wires, IR extender specific wireless, or piggybacked on network or coax). Another embodiment may use automation devices such as X-10 to control the internal devices. If the embodiment is simple enough, only the single connection from the data storage interface to outside the box is required and there may be no need for a communications interconnector such as the Ethernet switch 8.

The figures show a plurality of sensors used to monitor the health and state of the internal devices. In a environmental location where any of these sensors are not needed, an embodiment could omit the unnecessary sensors. Also, additional sensors known to those skilled in the art could be provided where the environment warrants.

While this invention has been particularly shown and described with references to preferred embodiments thereof, it will be understood by those skilled in the art that various changes in form and details may be made therein without departing from the scope of the invention encompassed by the appended claims.

What is claimed is:

1. A system comprising an environmentally protected box approximating the size of a shoebox of sufficient structural rigidity to withstand an underground environment, a data storage interface internal to the box with the ability to communicate with predetermined external information processors; wherein information stored within any data storage units within the box is protected from loss from destructive environmental forces.

2. The system in claim 1 wherein the material used to construct the box consists of one of the following: concrete, stainless steel, vinyl, plastic, glass, rubber, composites, and combinations of the forgoing.

3. The system in claim 1 wherein the box contains a top and a bottom with an environmentally protective seal.

4. The system in claim 1 further comprising a communications interconnector connecting any internal information processing devices with an external information processor.

5. The system in claim 4 further comprising a plurality of sensor units at predetermined internal surfaces connected to the communications interconnector and a communications interconnector connecting any sensor units with predetermined external information processors.

6. The system in claim 1 further comprising a temperature controller including a heat transfer or heat pump device.

7. The system in claim 1 wherein the underground environment is greater than a predetermined depth to avoid the freeze thaw cycle.

8. The system in claim 1 wherein the box of sufficient rigidity is of a predetermined construction to withstand an underground environment with a freeze thaw cycle.

9. The system as in claim 2 wherein the materials do not degrade when exposed to water, humidity, heat, flame, cold, and is impervious to insect, animals, and other active agents.

10. The system as in claim 2 wherein the materials are such as to protect the internal components against invasions of water and humidity.

11. The system as in claim 2 wherein the materials are such as to protect the internal components against invasions fire and heat.

12. The system as in claim 2 wherein the materials provide a Faraday cage for excessive voltage protection.

13. The system in claim 1 further comprising an external power source for driving the various components within the box.

14. The system as in claim 13 further comprising an internal power source which will provide for short or long term power as an uninterruptible power supply (UPS).

15. The system as in claim 13 further comprising an internal power conditioning device.

16. The system as in claim 1 where the communications transport comprises a wireless interconnection.

17. The system as in claim 1 where the communications transport comprises a cable.

18. The system as in claim 1 further comprising control-components for various components within the box.

19. The system as in claim 1 further comprising an external antenna.

20. The system as in claim 1 further comprising at least one data storage unit.
